(19) United States
(12) Patent Application Publication
(10) Pub. No.: US 2011/0052140 A1
(43) Pub. Date: Mar. 3, 2011

(54) IMAGE EDITING DEVICE AND IMAGING DEVICE PROVIDED WITH THE IMAGE EDITING DEVICE, IMAGE REPRODUCTION DEVICE AND IMAGING DEVICE PROVIDED WITH THE IMAGE REPRODUCTION DEVICE

(75) Inventors: Tsugio MORI, Ibi-Gun (JP); Shigeyuki Okada, Ogaki City (JP)

(73) Assignee: SANYO ELECTRIC CO., LTD.

(21) Appl. No.: 12/870,538

(22) Filed: Aug. 27, 2010

(30) Foreign Application Priority Data
Aug. 28, 2009 (JP) 2009-198214
Aug. 28, 2009 (JP) 2009-198220
Jul. 15, 2010 (JP) 2010-160237

(51) Int. Cl. H04N 5/77; H04N 5/93; H04N 5/775

(52) U.S. Cl. 386/224; 386/284; 386/230; 386/E05.069; 386/E05.028; 386/E05.07

(57) ABSTRACT

A decoding unit is configured to decode one of coded data for a video of a first image quality and coded data for a video of a second image quality different from the first image quality, the videos sharing the same image content. An editing unit is configured to edit, by user control, the video of the first image quality or the video of the second image quality decoded by the decoding unit. The editing unit causes an editing operation applied to one of the video of the first image quality and the video of the second image quality to be reflected in the coded data for the other video irrespective of user control.

This application is based upon and claims the benefit of priority from the prior Japanese Patent Applications No.2009-198214, filed on Aug. 28, 2009, Japanese Patent Application No. 2009-198220, filed on Aug. 28, 2009, and Japanese Patent Application No. 2010-160237, filed on Jul. 15, 2010, the entire contents of which are incorporated herein by reference.

### BACKGROUND OF THE INVENTION

1. Field of the Invention

The present invention relates to an image editing device adapted to edit a video, an imaging device provided with the image editing device, to an image reproduction device adapted to decode coded video data, reproduce the data, and display the video on a predetermined display device, and to an imaging device provided with the image reproduction device.

2. Description of the Related Art

Recently, digital camcorders that allow casual users to shoot a video have become widely available. Some camcorders are capable of capturing full HD (1920×1080) videos. Videos captured by such digital camcorders are used for various purposes. For example, videos may be viewed on a television or a PC, attached to an e-mail message and transmitted, or uploaded to a video sharing site, a blog site, or an SNS site on the Internet.

Videos captured at the full HD resolution are of high quality and are suitably viewed on a high-vision TV. However, data for videos captured at the full HD resolution will be voluminous and are not suitable for attachment to and transmission via e-mail messages or for uploading to a site on the Internet. For example, many of video sharing sites, blog sites, and SNS sites impose restriction on the volume of video image uploaded.

Therefore, for uploading to a site on the Internet, videos captured at the full HD resolution need be imported into a PC and converted into videos at a lower resolution and/or a lower frame rate before being uploaded.

Another approach is to code videos of a plurality of different image quality levels in parallel at imaging and to produce a plurality of video files of different image quality levels. For example, two encoders may be provided in a digital camcorder so that two video files of different image quality levels are produced.

On an increasing number of occasions, more video files sharing the same image content and having different image quality levels are generated than in the related art.

### SUMMARY OF THE INVENTION

The image editing device according to an embodiment of the present invention comprises: a decoding unit configured to decode one of coded data for a video of a first image quality and coded data for a video of a second image quality different from the first image quality, the videos sharing the same image content; and an editing unit configured to edit the video of the first image quality or the video of the second image quality decoded by the decoding unit. The editing unit causes an editing operation initiated by the user and applied to one of the video of the first image quality and the video of the second image quality to be reflected in the coded data for the other video irrespective of user control.

Another embodiment of the present invention relates to an imaging device. The imaging device comprises: an imaging unit configured to capture a video; a coding unit configured to code the video imaged by the imaging unit both in the first image quality and in the second image quality; and the aforementioned image editing device.

The image reproduction device according to an embodiment of the present invention comprises: a decoding unit configured to selectively decode coded data for a video of a first image quality and coded data for a video of a second image quality lower than the first image quality, the videos sharing the same image content; and a control unit configured to cause the video of the first image quality or the video of the second image quality, which is decoded by the decoding unit, to be displayed on a display device. The control unit may cause the video of the first image quality to be displayed when normal playback is requested and cause the video of the second image quality to be displayed when fast-forward or rewind is requested. The control unit may cause the video of the second image quality to be displayed when normal playback is requested and cause the video of the first image quality to be displayed when slow motion forward or slow motion rewind is requested. When fast forward or rewind is requested while normal playback of the video of the first image quality is proceeding or when the playback is suspended, the control unit may switch from the video of the first image quality to the video of the second image quality for display. When slow motion forward or slow motion rewind is requested while normal playback of the video of the second image quality is proceeding or when the playback is suspended, the control unit may switch from the video of the second image quality to the video of the first image quality for display.

Another embodiment of the present invention relates to an imaging device. The image reproduction device comprises: an imaging unit configured to capture a video; a coding unit configured to code the video imaged by the imaging unit both in the first image quality and in the second image quality; the aforementioned image reproduction device; and a display device configured to display the video reproduced by the image reproduction device.

Optional combinations of the aforementioned constituting elements, and implementations of the invention in the form of methods, apparatuses, systems, recording mediums and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the configuration of an imaging device provided with an image processing device according to the first embodiment;

FIG. 2 shows a relation between a frame image supplied to the branch unit, a frame image coded by the first image coding unit, and a frame image coded by the second image coding unit;

FIG. 3 shows the configuration of an image display system provided with an image editing device according to the second embodiment;

FIG. 4 shows an editing operation in the image editing device according to the second embodiment;

FIG. 5 shows the timing of switching between a single encoding mode in which the video is coded in HD size and a dual encoding mode in which the video is coded in HD size and in SD size, by way of example;

FIG. 6 shows the configuration of an image display system provided with an image reproduction device according to the third embodiment;

FIG. 7 is a table defining the correspondence between the type of instruction for playback and the image quality of reproduction in the first example of operation of the image reproduction device according to the third embodiment;

FIG. 7A shows a table according to the exemplary operation 1-1, and FIG. 7B shows a table according to the exemplary operation 1-2;

FIG. 8 shows an example of transition of image quality of a video played back in the second example of operation of the image reproduction device according to the third embodiment;

FIG. 8A shows an example of transition including a period for fast playback, and FIG. 8B shows an example of transition including a period for slow playback;

FIG. 9 shows the configuration of the imaging device provided with the processing device according to the variation; and

FIG. 10 shows an elaborated version of the example of FIG. 2 based on the variation.

### DETAILED DESCRIPTION OF THE INVENTION

The invention will now be described by reference to the preferred embodiments. This does not intend to limit the scope of the present invention, but to exemplify the invention.

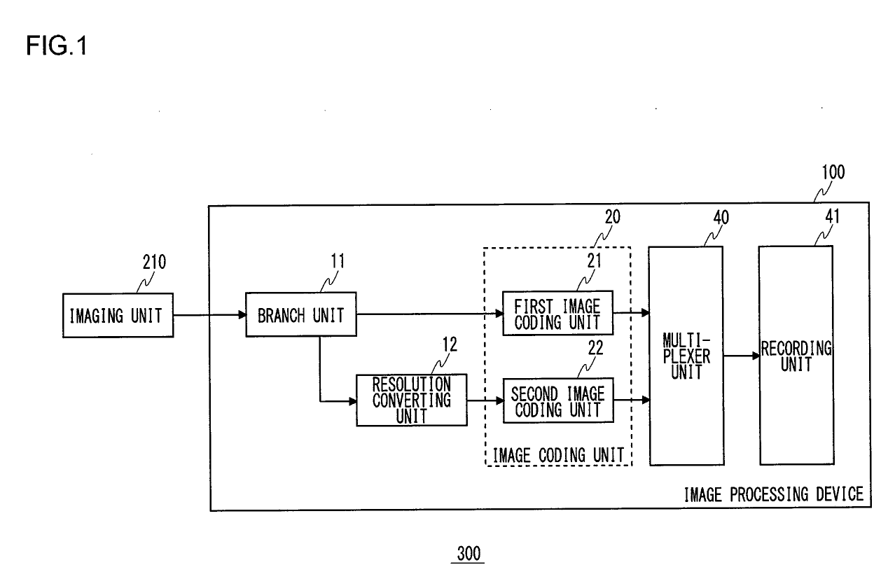

FIG. 1 shows the configuration of an imaging device 300 provided with a processing device 100 according to the first embodiment. The imaging device 300 comprises an imaging unit 210 and a sound acquisition unit 220.

The imaging unit 210 captures frame images in succession and supplies a resultant video to the processing device 100. The imaging device 210 is provided with a solid-state imaging device such as a charge coupled device (CCD) sensor and a complementary metal oxide semiconductor (CMOS) image sensor, and a signal processing circuit (not shown) for processing a signal output from the solid-state imaging device. The signal processing circuit is capable of converting analog R, G, B signals output from the solid-state imaging device into a digital luminance signal Y and color difference signals Cr, Cb.

The processing device 100 primarily processes videos captured by the imaging unit 210. The processing device 100 includes a branch unit 11, a resolution converting unit 12, an image coding unit 20, a sound coding unit 30, a multiplexer unit 40, and a recording unit 41. The image coding unit 20 includes a first image coding unit 21 and a second image coding unit 22.

The configuration of the processing device 100 is implemented by hardware such as a processor, memory, or other LSIs and by software such as a program or the like loaded into the memory. FIG. 1 depicts functional blocks implemented by the cooperation of hardware and software. Therefore, it will be obvious to those skilled in the art that the functional blocks may be implemented in a variety of manners by hardware only, software only, or a combination of thereof.

The branch unit 11 outputs the video supplied from the image coding unit 210 to the first image coding unit 21 and the resolution converting unit 12.

The resolution converting unit 12 converts the resolution of frame images forming the video supplied from the branch unit 11. It will be assumed that the resolution converting unit 12 lowers the resolution of the frame images. The resolution converting unit 12 may reduce the resolution by cropping an area at the center of the frame image and removing the surrounding area. Alternatively, the unit 12 may lower the resolution by down-sampling pixels within the frame image. The resolution converting unit 12 outputs the video formed by the frame images subjected to resolution conversion to the second image coding unit 22.

The image coding unit 20 is capable of coding the video captured by the imaging unit 210 in the first image quality and in the second image quality different from the first image quality, in parallel or simultaneously. In other words, the image coding unit 210 is capable of subjecting a single type of video to dual codec coding. Referring to FIG. 1, the first image coding unit 21 is capable of coding the video supplied from the branch unit 11, and the second image coding unit 22 is capable of coding video supplied from the resolution converting unit 12 in parallel or simultaneously.

The video of the first image quality and the video of the second image quality are coded at different resolutions. An extensive variety of combinations of the resolution of the video of the first image quality and the resolution of the video of the second image quality will be possible. For example, any two of the pixel sizes 1920×1080, 1280×720, 640×480, 448×336, and 192×108 may be used in combination.

Further, the video of the first image quality and the video of the second image quality may be coded at different frame rates as well as being coded at different resolutions. For example, any two of the frame rates 60 fps, 30 fps, and 15 fps may be used in combination. Alternatively, a high frame rate such as 240 fps or 600 fps may be assigned to low resolutions such as 448×336 pixel size and 192×108 pixel size.

The image coding unit 20 subjects the video of the first image quality and the video of the second image quality to compression coding according to a predetermined standard. For example, the unit 20 is capable of compression coding according to a standard such as H.264/AVC, H.264/SVC, MPEG-2, and MPEG-4.

The image coding unit 20 may code the video of the first image quality and the video of the second image quality in a time-divided manner using a single hardware encoder or using a software process on a general-purpose processor. Alternatively, the unit 20 may code the video of the first image quality and the video of the second image quality in parallel using two hardware encoders. The image coding unit 20 outputs coded data (also referred to as a coded data stream) for the video of the first image quality and code data for the video of the second image quality to the multiplexer unit 40.

The multiplexer unit 40 multiplexes the coded data for the video of the first image quality supplied from the first image coding unit 21 and the code data for the video of the second image quality supplied from the second image coding unit 22 so as to produce a single video file. For example, the unit 40 is capable of producing a container file conforming to the MP4 file format. The container file can contain a container describing header information, meta data, or time information of the coded data. By allowing the decoding end to refer to the container file, synchronization between the video of the first image quality and the video of the second image quality is facilitated and random access is facilitated.

The recording unit 41 records the video file multiplexed by the multiplexer unit 40 in a recording medium. At least one of a built-in memory and a detachable removable memory may be used as a recording medium. For example, a semiconductor memory or a hard disk may be employed as a built-in memory. A memory card, removable hard disk, or optical disk may be employed as a removable memory.

An input and output unit (not shown) of the imaging device 300 communicates with an external device via a predetermined interface. For example, the input and output unit may be connected to a PC or an external hard disk using a USB cable to transfer the video file recorded in the recording medium to the PC or the external hard disk. Alternatively, the input and output unit may be connected to a television using a D terminal, S terminal, or HDMI terminal to display the video of the first image quality or the video of the second image quality on a television screen.

A description will now be given of the operation of the image processing device 100 according to the embodiment, using an example where the video of the first image quality comprises frame images of HD (1280×720) size, and the video of the second image quality comprises frame images of SD (640×480) size.

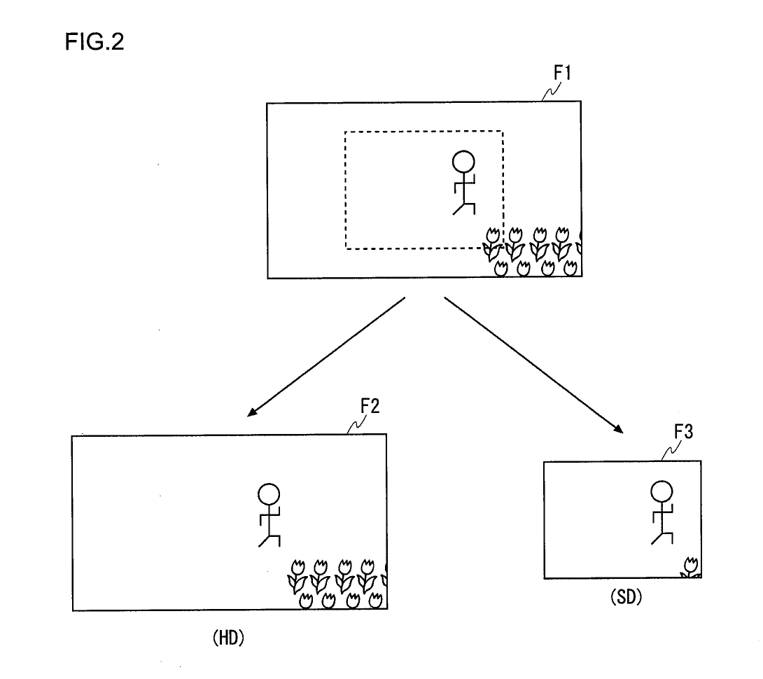

FIG. 2 shows a relation between a frame image F1 supplied to the branch unit 11, a frame image F2 coded by the first image coding unit 21, and a frame image F3 coded by the second image coding unit 22. In the above example, the frame image F1 of HD size is supplied to the branch unit 11. The frame images supplied to the image processing device 100 from the imaging unit 210 may include areas for anti-blurring correction. It will be assumed that pixel data for areas for anti-blurring correction are cropped before being supplied to the branch unit 11.

The branch unit 11 outputs the frame image F1 of HD size to the first image coding unit 21 and the resolution converting unit 12. The resolution converting unit 12 converts the frame image F1 of HD size into the frame image F3 of SD size. The first image coding unit 21 directly codes the frame image F1 of HD size supplied from the branch unit 11. The second image coding unit 22 codes the frame image F3 of SD size supplied from the resolution converting unit 12.

The aspect ratio of the frame image F2 of HD size coded by the first coding unit 21 is 16:9, and the aspect ratio of the frame image F3 of SD size coded by the second coding unit 22 is 4:3. The frame image F3 of SD size is produced by leaving the central area of the frame image F2 of HD size and removing the surrounding area.

The coded data for the video of HD size coded by the first image coding unit 21 is suited to the purpose of storage for viewing on a PC or television, and the coded data for the video of SD size coded by the second image coding unit 22 is suited to the purpose of attaching to an e-mail message for transmission or posting the scene on a site on the Internet. Thus, the user may appropriately select and use the coded data for the video of HD size or the coded data for the video of SD size.

As described above, the first embodiment ensures that the video is dual-encoded at imaging so that the necessity for transcoding of a video file is reduced. By producing coded data for videos of two types of image quality, the two types of coded data can be used to suit the purpose so that the frequency of transcoding is reduced.

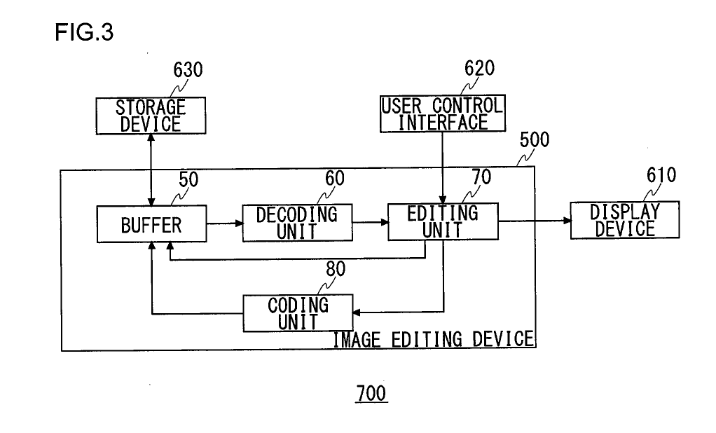

FIG. 3 shows the configuration of an image editing system 700 provided with an image editing device 500 according to the second embodiment. The image editing system 700 is provided with an image editing device 500, a display device 610, a user control interface 620, and a storage device 630.

Various hardware configuration may be used to form the image editing system 700. For example, the image editing system 700 may be built by the imaging device 300 and a television connected to the device 300 by cable. In this case, the image editing device 500 can be built using the control function of the imaging device 300. The user control interface 620 can be built using the user control function of the imaging device 300. The storage device 630 can be built using the storage function of the imaging device 300. The display device 610 can be built using the display function of the television.

The image editing system 700 can be built using the PC receiving the video file produced by the image processing device 100 according to the first embodiment. In this case, the image editing device 500, the user control interface 620, the storage device 630, and the display device 610 can be built using the control function, the user control function, the storage function, and the display function of the PC, respectively. The same is true of a case where a cell phone, a PDA, or a portable music player is used in place of a PC.

The image editing system 700 can be built only by using the imaging device 300 described above. In this case, the image display control device 500, the user control interface 620, the storage device 630, and the display device 610 may be built using the control function, the user control function, the storage function, and the display function of the imaging device 300, respectively. The imaging device 300 includes the image processing device 100 according to the first embodiment.

The image editing device 500 includes a buffer 50, a decoding unit 60, an editing unit 70, and a coding unit 80. The configuration of the image editing device 500 is implemented by hardware such as a processor, a memory, or other LSIs and by software such as a program or the like loaded into the memory. FIG. 3 depicts functional blocks implemented by the cooperation of hardware and software. Therefore, it will be obvious to those skilled in the art that the functional blocks may be implemented in a variety of manners by hardware only, software only, or a combination of thereof.

The storage device 630 comprises the aforementioned recording medium (semiconductor memory, hard disk, etc.) and stores the video file produced by the image processing device 100 according to the first embodiment. When accessed by the image editing device 500, the storage device 630 outputs the video file to the buffer 50 in the image editing device 500.

The buffer 50 temporarily stores the video file input from the storage device 630. The buffer 50 supplies the coded data for the video of the first image quality and the coded data for the video of the second image quality, which are included in the video file, to the decoding unit 60 in accordance with a control signal from the editing unit 70. More specifically, the buffer 50 supplies the coded data for the video subject to editing by the user to the decoding unit 60.

The decoding unit 60 decodes one of the coded data for the video of the first image quality and the coded for the video of the second image quality sharing the same image content. More specifically, the decoding unit 60 decodes the coded data for the video of the first image quality or the coded for the video of the second image quality supplied from the buffer 50. For example, the video of the first image quality may be a video of HD size, and the video of the second image quality may be a video of SD size.

The user control interface 620 acknowledges a user instruction, generates a control signal based on the instruction, and outputs the control signal to the editing unit 70. The user control interface 620 primarily acknowledges user control for various editing operations. Various editing operations include cut and paste of an image, effect process, text insertion, audio insertion, etc.

The editing unit 70 edits the video of the first image quality or the video of the second image quality decoded by the decoding unit 60. More specifically, the editing unit 70 causes an editing screen including a reproduction screen for the video selected as a target of editing to be displayed on the display device 610. The user performs various editing operations by using the user control interface 620 while viewing the editing screen. For example, the user deletes unwanted scenes. The user may cut a plurality of scenes and creates a separate video file or a play list by stitching the cut scenes. Alternatively, the user may insert a message in a selected frame or insert BGM in a selected scene.

The editing unit 70 causes the editing operation initiated by the user and applied to one of the video of the first image quality and the video of the second image quality to be reflected in the coded data for the other video irrespective of user control. For example, when a scene in the video of the first image quality is deleted by user control, the corresponding scene in the video of the second image quality is deleted.

Prior to causing the editing operation applied to one of the video of the first image quality and the video of the second image quality to be reflected in the other, a message may be presented, prompting the user to confirm whether the editing operation should be reflected in the other video. For example, a message such as “To be reflected in SD-size video?” may be displayed in the screen of the display device 610. Alternatively, a sound message may be output from a sound output unit (not shown). When the user selects OK via the user control interface 620, the editing unit 70 causes the operation to be reflected in the other of the videos. When the user selects NG, the unit 70 aborts the process of reflection.

When processing a frame image itself (e.g., insert a test in the frame image or change the frame image into a sepia tone, etc.), the editing unit 70 outputs the processed image to the coding unit 80. The coding unit 80 codes the processed image as input and outputs the coded image to the buffer 50. The editing unit 70 also causes the coded data for the other video in the buffer 50 to be decoded by the decoding unit 60 so as to reflect the process in that coded data. The editing unit 70 applies a similar process to the decoded video and causes the coding unit 80 to code the processed image.

Meanwhile, when performing an editing operation (e.g., deletion or cut of a scene) that does not affect a frame image, the editing unit 70 can directly edit the coded data for the video stored in the buffer 50 and subject to editing. The editing unit 70 can also directly edit the coded data for the other video in the buffer 50. For example, the frame image of the scene directed to be deleted may simply be removed from the coded data for both videos.

Of various types of editing operations, deletion of a scene should be performed with care because once a scene is deleted it is difficult to restore the scene. When a video of a high image quality (e.g., HD size) and a video of a low image quality (e.g., SD size) coexist, user may have different intentions in deleting a scene of the former video and in deleting a scene of the latter video.

In other words, since high-quality videos are primarily used for the purpose of storage, deletion of a scene is relatively often based on the user decision that the scene is not necessary. In contrast, since low-quality videos are primarily for e-mail transmission or upload to a site on the Internet, deletion of a scene is relatively often performed mainly for the purpose of reducing the volume.

The process in which the above discussion is reflected will be explained. Given the video of the first image quality and the video of the second image quality, when a segment of the video of the higher image quality is deleted by user control, the editing unit 70 deletes the corresponding segment in the video of the lower image quality. In other words, the operation is reflected in the video of the lower image quality because it is likely that the segment is an unnecessary scene for the user.

Meanwhile, when a segment of the video of the lower image quality is deleted by user control, the editing unit 70 does not delete the corresponding segment in the video of the higher image quality unconditionally. This is because it is likely that the user wishes to retain the scene of the segment but deleted it due to the need for reducing the volume for the purpose uploading to a site on the Internet. To let the user validate or invalidate the possibility, the editing unit 70 may present a message, prompting the user to verify whether the corresponding segment in the video of the higher quality should be deleted. When the user selects OK in response, the corresponding segment is deleted. When the user selects NG, the deletion is aborted.

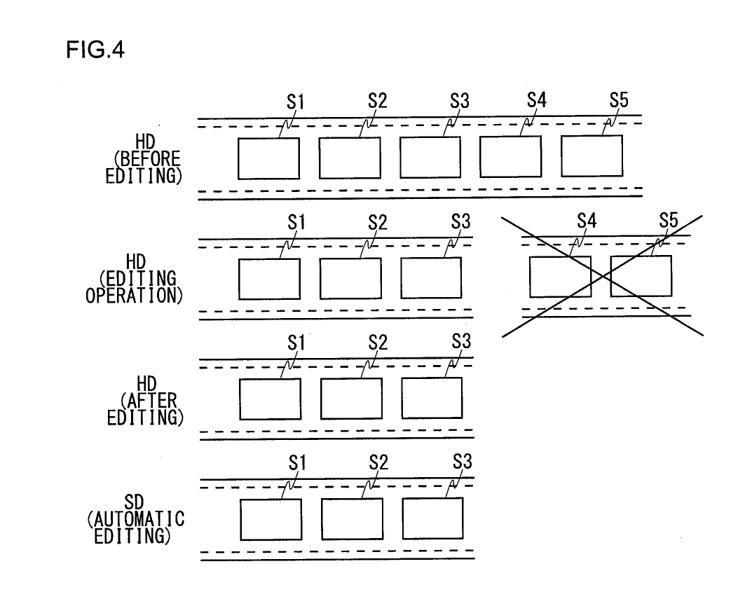

FIG. 4 shows an editing operation in the image editing device 500 according to the second embodiment. FIG. 4 assumes that the coded data for the video of HD size and the code data for the video of SD size sharing the same image content coexist. In this case, the user edits a video of HD size. The editing screen of the display device 610 displays video frames of HD size. FIG. 4 shows the first frames (i.e., frames immediately following the previous scenes) of five scenes (first scene S1-fifth scene S5). The user does not need the fourth scene S4 and the fifth scene S5 and deletes the scenes in an editing operation. The editing unit 70 reflects the manual editing operation in the video of SD size. In other words, the unit 70 deletes the fourth scene S4 and the fifth scene S5 of SD size using an automated editing process.

As described above, the second embodiment offers improvement in user convenience experienced when editing a plurality of video files sharing the same image content and having different image quality levels. A case will be considered where a video file of a high image quality and a video file of a low image quality coexist. In this case, user workload required for editing can be reduced by reflecting the editing operation applied in one of the video files in the other. Labor required for editing can be reduced to half for the user attempting to edit both video files in the same manner.

Another advantage is that the consistency in editing operations in the video files is maintained. The advantage is suitable for the user attempting to apply completely the same editing operation to the video files. Manual editing of the video files may not result in the same editing operation being applied to the files. According to the embodiment, consistency in the editing operations is maintained and the labor required for the editing operations is reduced as well.

In cases where it is likely that the user does not wish the editing operation in one of the video files to be reflected in the other, the operation is not reflected or the user is prompted for confirmation so that the user intent is reflected. For example, when deletion of a part of the scenes of the video file of lower image quality is attempted, it is likely that the user intends to reduce the volume so that the deletion is not unconditionally reflected in the video file of higher image quality.

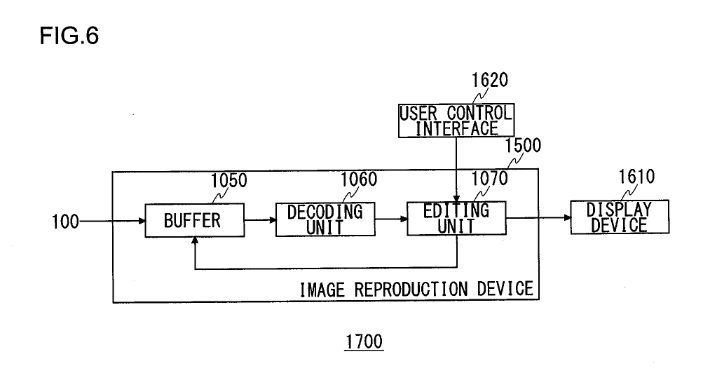

FIG. 6 shows the configuration of an image display system 1700 provided with an image reproduction device 1500 according to the third embodiment. The image display system 1700 is provided with an image reproduction device 1500, a display device 1610, and a user control interface 1620.

Various hardware configuration may be used to form the image display system 1700. For example, the image display system 1700 may be built by the imaging device 300 and a television connected to the device 300 by cable. In this case, the image reproduction device 1500 can be built using the control function of the imaging device 300. The user control interface 1620 can be built using the user control function of the imaging device 300. The display device 1610 can be built using the display function of the television.

The image display system 1700 can be built using the PC receiving the video file produced by the image processing device 100 according to the first embodiment. In this case, the image reproduction device 1500, the user control interface 1620, and the display device 1610 can be built using the control function, the user control function, and the display function of the PC, respectively. The same is true of a case where a cell phone, a PDA, or a portable music player is used in place of a PC.

The image display system 1700 can be built using only the imaging device 300 described above. In this case, the image reproduction device 1500, the user control interface 1620, and the display device 1610 may be built using the control function, the user control function, and the display function of the imaging device 300, respectively. The imaging device 300 includes the image processing device 100 according to the first embodiment.

The image reproduction device 1500 includes a buffer 1050, a decoding unit 1060, and a control unit 1070. The configuration of the image reproduction device 1500 is implemented by hardware such as a processor, a memory, or other LSIs and by software such as a program or the like loaded into the memory. FIG. 6 depicts functional blocks implemented by the cooperation of hardware and software. Therefore, it will be obvious to those skilled in the art that the functional blocks may be implemented in a variety of manners by hardware only, software only, or a combination of thereof.

The buffer 1050 temporarily stores the video file produced by the image processing device 100 according to the first or second embodiment. The buffer 1050 supplies the coded data for the video of the first image quality or the coded data for the video of the second image quality, which are included in the video file, to the decoding unit 1060 in accordance with a control signal from the control unit 1070.

The decoding unit 1060 selectively decodes the coded data for the video of the first image quality and coded data for the video of the second image quality lower than the first image quality, the coded data sharing the same image content. More specifically, the decoding unit 1060 decodes the coded data for the video of the first image quality or the coded for the video of the second image quality supplied from the buffer 1050. For example, the video of the first image quality may be the video of HD size, and the video of the second image quality may be the video of SD size. Coding of the video of the first image quality and the video of the second image quality in different resolutions is described by way of example in the first through third embodiments.

The user control interface 1620 acknowledges a user instruction, generates a control signal based on the instruction, and outputs the control signal to the control unit 1070. In this embodiment, the interface 1620 primarily acknowledges various types of instruction for playback of a high-quality video or a low-quality video and an instruction for suspending reproduction. Various types of instruction for playback include instructions for special types of playback (e.g., fast-forward, rewind, slow motion forward, slow motion rewind).

The control unit 1070 causes the video of high image quality or the video of low image quality decoded by the decoding unit 1060 to be displayed on the display device 1610. When a control signal initiated by any of various instructions for playback is input from the user control interface 1620, the control unit 1070 causes the video of the image quality determined by the type of instruction for playback to be displayed on the display device 1610.

A description will now be given of the first example of operation. In the first example of operation, the correspondence between type of instruction for playback and the image quality of reproduction is established. In the exemplary operation 1-1 described below, normal playback is configured for high image quality. In the exemplary operation 1-2, normal playback is configured for low image quality. For example, the exemplary operation 1-1 is suitable for playing back a video using high-specification hardware resources such as a PC. The exemplary operation 1-2 is suitable for playing back a video using low-specification hardware resources such as a mobile device. By performing normal playback in a low image quality, reduction of the load required for playback and reduction of power consumption are facilitated.

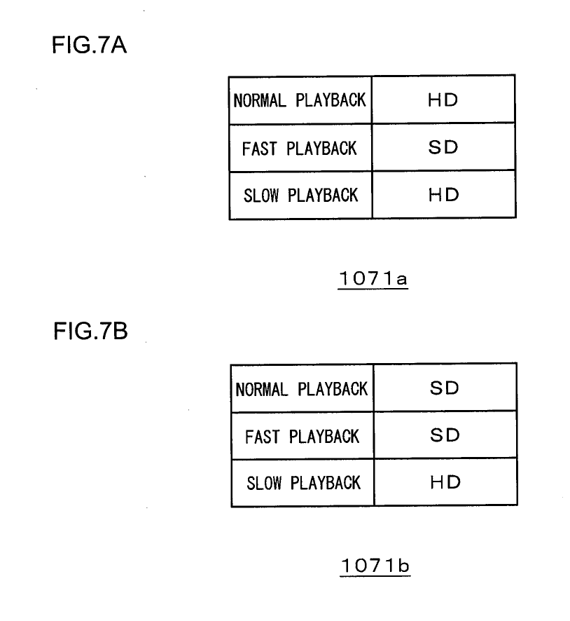

FIG. 7 is a table defining the correspondence between the type of instruction for playback and the image quality of reproduction in the first example of operation of the image reproduction device 1500 according to the third embodiment. FIG. 7A shows a table 1071a according to the exemplary operation 1-1, and FIG. 7B shows a table 1071b according to the exemplary operation 1-2.

As shown in FIG. 7A, the control unit 1070 in the exemplary operation 1-1 causes the video of high image quality (in this case, HD size) to be displayed on the display device 1610 when normal playback is requested. When fast-forward or rewind (hereinafter, referred to as fast playback) is requested, the unit 1070 causes the video of low image quality (in this case, SD size) to be displayed. When slow motion forward or slow motion rewind (hereinafter, generically referred to as slow motion playback) is requested, the control unit 1070 causes the video of high image quality (in this case, HD size). Slow motion playback includes frame-by-frame forward or frame-by-frame rewind.

As shown in FIG. 7B, the control unit 1070 in the exemplary operation 1-2 causes the video of low image quality (in this case, SD size) to be displayed on the display device 1610 when normal playback is requested. When slow playback is requested, the unit 1070 causes the video of high image quality (in this case, HD size) to be displayed. When fast playback is requested, the control unit 1070 causes the video of low image quality (in this case, SD size) to be displayed.

A description will now be given of the second example of operation. The first example of operation concerns a case where a video is played back in the predefined image quality when the user gives an instruction for normal playback. In the second example of operation, the user can designate an image quality when giving an instruction for normal playback. For example, the user may select one of the video file of high image quality and the file of low image quality displayed in the screen so as to play back the video.

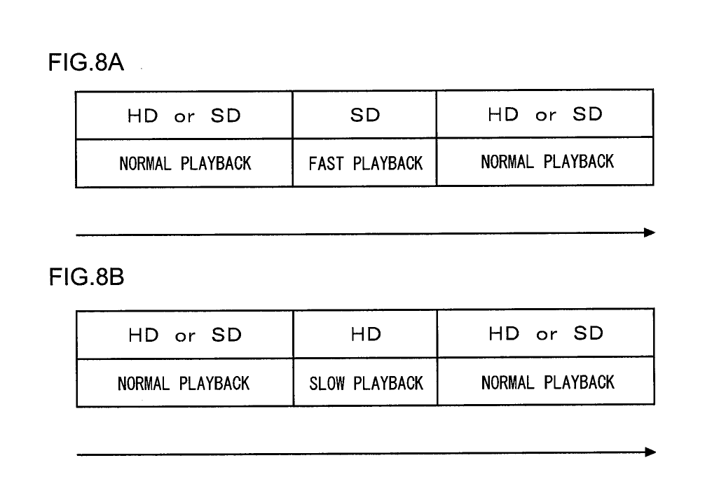

FIG. 8 shows an example of transition of image quality of a video played back in the second example of operation of the image reproduction device 1500 according to the third embodiment. FIG. 8A shows an example of transition including a period for fast playback, and FIG. 8B shows an example of transition including a period for slow playback.

As shown in FIG. 8A, when fast playback is requested while normal playback of the video of high image quality is proceeding or when the playback is suspended, the control unit 1070 switches from the video of high image quality to the video of low image quality for display on the display device 1610. When fast playback is requested while normal playback of the video of low image quality is proceeding or when the playback is suspended, the video of low image quality continues to be displayed.

When normal playback is requested while fast playback of the video of low image quality is proceeding or when the playback is suspended, the control unit 1070 returns to the image quality displayed during the normal playback prior to the fast playback. For example, when the video of high image quality was displayed during normal playback prior to the fast playback, the control unit 1070 switches from the video of low image quality to the video of high image quality for display on the display device 1610.

Further, as shown in FIG. 8B, when slow motion playback is requested while normal playback of the video of low image quality is proceeding or when the playback is suspended, the control unit 1070 switches from the video of low image quality to the video of high image quality for display on the display device 1610. When normal playback is requested while fast playback of the video of high image quality is proceeding or when the playback is suspended, the video of high image quality continues to be displayed.

When normal playback is requested while slow motion playback of the video of high image quality is proceeding or when the playback is suspended, the control unit 1070 returns to the image quality displayed during the normal playback prior to the slow motion playback. For example, when the video of low image quality was displayed during normal playback prior to the slow motion playback, the control unit 1070 switches from the video of high image quality to the video of low image quality for display on the display device 1610.

As described above, all frames may be decoded and played back in fast playback of the coded data for the video of low image quality. Alternatively, the decoding operation may skip some of the frames. For example, when the coded data for the video is encoded according to the MPEG series standard, I frames and P frames are decoded and B frames are skipped.

As described above, according to the third embodiment, when any of a plurality of video files sharing the same image content and having different image quality levels are played back in a special playback mode, the video is played back such that increase in the load required for playback is mitigated and display quality is improved at the same time. For example, it will be assumed that the video file of high image quality and the video file of low image quality coexist. When fast playback is requested, the video of low image quality is played back in a fast playback mode irrespective of the situation occurring prior to the request (e.g., even during the normal playback of the video of high image quality). This ensures that as much frame images as possible are played back.

In other words, it is difficult to play back all of the frames in the video of high image quality in a fast playback mode without increasing the processing capability significantly using high-specification hardware resources. Therefore, for fast playback of the video of high image quality, it is common to play back the video using selected frames. For example, where the video of high image quality is coded according to the MPEG series standard, I frames are decoded and P frames and B frames are skipped. In this case, the number of frames played back is extremely small, resulting in jerky images with lots of after images.

In contrast, in the case of the video of low image quality, the processing load required per frame is smaller than the video of high image quality. Therefore, it is easy to increase the number of frames played back as compared with the video of high image quality. Therefore, smooth images with fewer after images can be displayed in a fast playback mode without using high-specification hardware resources and increasing the processing load.

When slow motion playback is requested, the video of high image quality is played back in a slow motion playback mode irrespective of the situation occurring prior to the request (e.g., even during the normal playback of the video of low image quality). In slow motion playback, time that can be consumed to process a single frame can be extended so that there will fewer frames dropped during playback even with low-specification hardware resources.

By switching between image quality levels automatically, display quality during special playback can be improved without increasing the labor for the user.

Described above is an explanation based on an exemplary embodiment. The embodiment is intended to be illustrative only and it will be obvious to those skilled in the art that various modifications to constituting elements and processes could be developed and that such modifications are also within the scope of the present invention.

The above description of the first and second embodiments assumes that a given video is continuously coded in both the first image quality and in the second image quality so as to produce the coded data for the video of the first image quality and the coded data for the video of the second image quality. In a variation, a given video is continuously coded in the first image so as to produce the coded data for the video of the first image quality and intermittently coded in the second image quality so as to produce the coded data for the video of the second image quality.

In other words, the dual encoding period in which the video is coded both in the first image quality and in the second image quality, and the single encoding period in which the video is coded only in the first image quality are established. The timing of switching between the dual encoding period and the single encoding period may be configured by user control at imaging. Alternatively, the timing may be automatically configured by the system. For example, a period in which a certain object (e.g., face) is detected in a frame image may be configured as a dual encoding period, and a period in which it is not may be configured as a single encoding period.

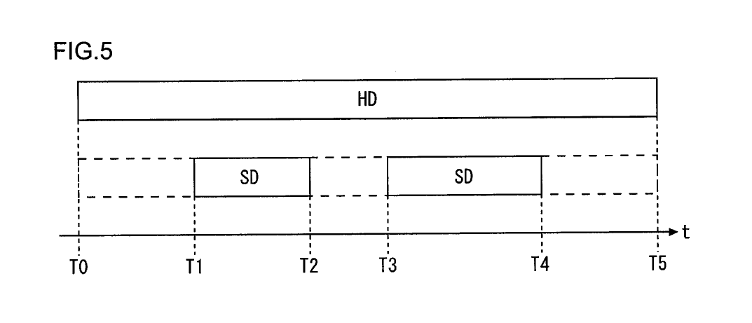

The description below assumes that the first image quality is HD size and the second image quality is SD size. FIG. 5 shows the timing of switching between a single encoding mode in which the video is coded in HD size and a dual encoding mode in which the video is coded in HD size and in SD size, by way of example. In this example, the video captured is continuously coded in HD size and intermittently coded in SD size.

When deletion of a segment(s) of the video of the first image quality (in this case, HD size) is requested by user control, the editing unit 70 determines whether the segment(s) is found in the video of the second image quality (in this case, SD size). If the segment designated in the request comprises a segment not found in the video of the second image quality (in this case, SD size), a message is presented, prompting the user to select whether to validate the request for deletion. When the user selects OK in response, the corresponding segment is deleted. When the user selects NG, the deletion is aborted.

If, in the example of FIG. 5, the scene in the video of HD size designated to be deleted includes a period T0-T1, a period T2-T3, or a period T4-T5, the editing unit 70 presents the above message to the user. When the scene including any of these periods is deleted, the video for that period will no longer be available for view and so the user is alerted. The user may assume that, even when a scene(s) of one of the video files is deleted, the image for the scene remains undeleted in the other video file. According to this variation, however, the single encoding period is included so that once the image in the period is deleted, it will be difficult to restore the image. According to this variation, the likelihood of deletion due to misunderstanding on the part of the user can be reduced.

The description of the second embodiment assumes that the image processing device 100 according to the first embodiment plays back two types of coded video data produced by dual encoding at imaging. The second embodiment is also applicable to a case where two types of coded video data are placed back, including the coded video data generated by post-imaging transcoding of a single type of coded video data produced by single encoding at imaging.

The description of the first and second embodiments assumes that two types of coded video data are generated and placed back. Alternatively, three or more types of coded video data may be generated and placed back. In this case, an editing operation in one of the coded video data may be reflected in all of the remaining coded video data or in some of the coded video data.

In the case in which one of the coded data for the video of the first image quality and the coded data for the video of the second image quality is located in the imaging device 300 and the other is located in a PC, synchronization of the editing operation described in the second embodiment is performed once the imaging device 300 and the PC are connected by cable or using a docking station. Synchronization of the editing operation may automatically be performed immediately after the device 300 and the PC are connected or performed on the condition that a user operation is performed. The same is true of connection between the imaging device 300 and other types of devices.

The description of the third embodiment assumes that the image processing device 100 according to the first embodiment plays back two types of coded video data produced by dual encoding at imaging. The third embodiment is also applicable to a case where two types of coded video data are played back, including the coded video data generated by post-imaging transcoding of a single type of coded video data produced by single encoding at imaging.

The description of the first and third embodiments assumes that two types of coded video data are generated and played back. Alternatively, three or more types of coded video data may be generated and played back. In this case, the coded data for the video of the lowest image quality may be played back when fast playback is requested. When slow motion playback is requested, the coded data for the video of the highest image quality may be played back.

Coding of the video of the first image quality and the video of the second image quality in different resolutions is described by way of example in the first through third embodiments. In the following variation, coding of the video of first image quality and the video of the second image quality in the same resolution and at different angles of view will be described by way of example.

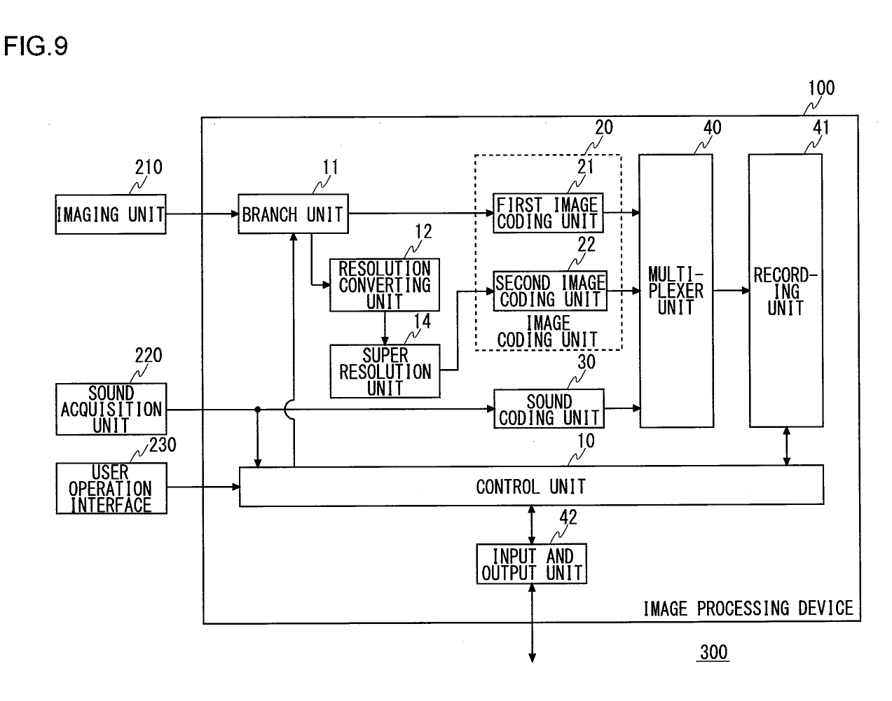

FIG. 9 shows the configuration of the imaging device 300 provided with the image processing device 100 according to the variation. The image processing device 100 of FIG. 9 is configured such that a super resolution unit 14 is added to the image processing device 100 of FIG. 1. Hereinafter, the description given above with reference to FIG. 1 will not be repeated. The super resolution unit 14 uses the super resolution technique to improve the resolution of the frame image in which the resolution is lowered by the resolution converting unit 12. For super resolution reconstruction, known methods using intraframe process and/or interframe process may be employed.

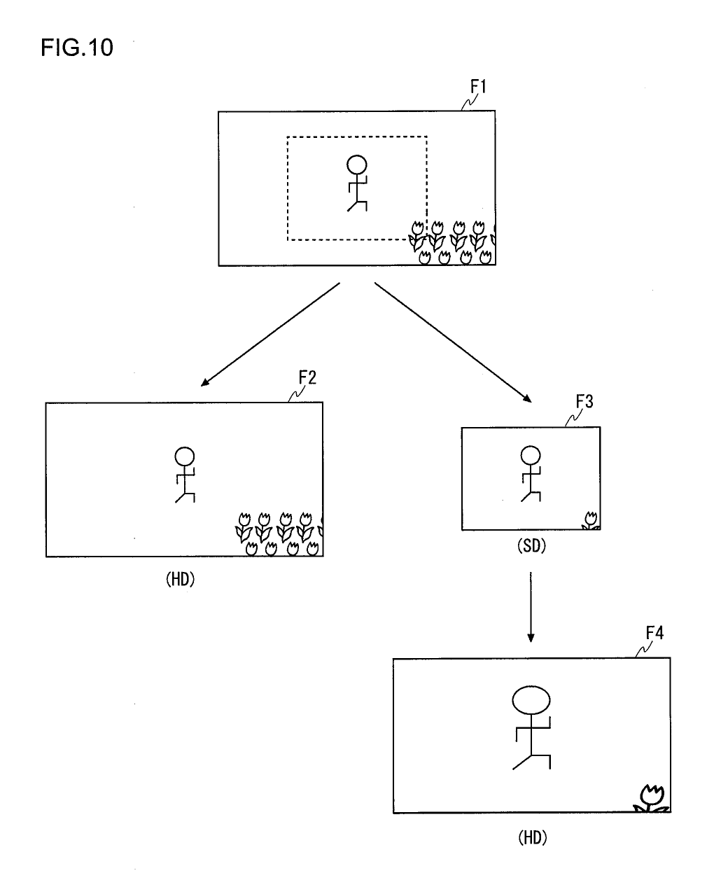

FIG. 10 shows an elaborated version of the example of FIG. 2 based on the variation described above. The frame image F1, the frame image F2, and the frame image F3 are as described with reference to FIG. 2. In this variation, the super resolution unit 14 transforms the frame image F3 into the frame image F4 of HD size. This will produce two frame images, namely, F2 and F4, having the same resolution and different angles of view.

The variations shown in FIGS. 9 and 10 are by way of example. The video of the first image quality and the video of the second image quality dual encoded by the imaging device 300 shall not be of the same resolution and the same angle of view but only have to differ at least in the resolution and the angle of view. An extensive variation of the arrangement of the resolution converting unit 12 and the super resolution unit 14 will be possible to achieve this. For example, the resolution converting unit 12 and the super resolution unit 14 may be provided between the branch unit 11 and the first image coding unit 21 so as to adjust the resolution and angle of view of the video of the first image quality.

According to this variation, the specification of the dual encoded video can be flexibly configured.

What is claimed is:

1. An image editing device comprising:
a decoding unit configured to decode one of coded data for a video of a first image quality and coded data for a video of a second image quality different from the first image quality, the videos sharing the same image content; and
an editing unit configured to edit the video of the first image quality or the video of the second image quality decoded by the decoding unit,
wherein the editing unit causes an editing operation initiated by the user and applied to one of the video of the first image quality and the video of the second image quality to be reflected in the coded data for the other video irrespective of user control.

2. The image editing device according to claim 1,
wherein the first image quality is higher than the second image quality, and, when a segment of the video of the first image quality is deleted by user control, the editing unit deletes the corresponding segment in the video of the second image quality, and
when a segment of the video of the second image quality is deleted by user control, the editing unit does not delete the corresponding segment in the video of the first image quality.

3. The image editing device according to claim 1,
wherein the first image quality is higher than the second image quality, and, when a segment of the video of the first image quality is deleted by user control, the editing unit deletes the corresponding segment in the video of the second image quality, and
when a segment of the video of the second image quality is deleted by user control, the editing unit presents a message, prompting the user to verify whether the corresponding segment in the video of the first image quality should be deleted.

4. The image editing device according to claim 1,
wherein the coded data for the video of the first image quality is produced by continuously coding a given video and the coded data for the video of the second image quality is produced by intermittently coding the given video,
when deletion of a segment of the video of the first image quality is requested by user control, the editing unit determines whether the segment is found in the video of the second image quality, and
if the segment designated in the request comprises a segment not found in the video of the second image quality, the editing unit presents a message, prompting the user to select whether to validate the request for deletion.

5. An imaging device comprising:
an imaging unit configured to capture a video;
a coding unit configured to code the video imaged by the imaging unit both in the first image quality and in the second image quality; and
an image editing device according to claim 1.

6. An image reproduction device comprising:
a decoding unit configured to selectively decode coded data for a video of a first image quality and coded data for a video of a second image quality lower than the first image quality, the videos sharing the same image content; and
a control unit configured to cause the video of the first image quality or the video of the second image quality, which is decoded by the decoding unit, to be displayed on a display device.

7. The image reproduction device according to claim 6,
wherein the control unit causes the video of the first image quality to be displayed when normal playback is requested and causes the video of the second image quality to be displayed when fast-forward or rewind is requested.

8. The image reproduction device according to claim 6,
wherein the control unit causes the video of the second image quality to be displayed when normal playback is requested and causes the video of the first image quality to be displayed when slow motion forward or slow motion rewind is requested.

9. The image reproduction device according to claim 6,
wherein, when fast forward or rewind is requested while normal playback of the video of the first image quality is proceeding or when the playback is suspended, the control unit switches from the video of the first image quality to the video of the second image quality for display.

10. The image reproduction device according to claim 6,
wherein, when slow motion forward or slow motion rewind is requested while normal playback of the video of the second image quality is proceeding or when the playback is suspended, the control unit switches from the video of the second image quality to the video of the first image quality for display.

11. An imaging device comprising:
an imaging unit configured to capture a video;
a coding unit configured to code the video imaged by the imaging unit both in the first image quality and in the second image quality;
an image reproduction device according to claim 6; and
a display device configured to display the video reproduced by the image reproduction device.
